(19) United States
(12) Patent Application Publication
(10) Pub. No.: US 2025/0073862 A1
(43) Pub. Date: Mar. 6, 2025

(54) WRENCH EXTENDER

(71) Applicant: Hong Ann Tool Industries Co., Ltd., Taichung City (TW)

(72) Inventor: Cheng-Wei SU, Taichung City (TW)

(21) Appl. No.: 18/952,812

(22) Filed: Nov. 19, 2024

Related U.S. Application Data
(63) Continuation-in-part of application No. 17/894,330, filed on Aug. 24, 2022.

(30) Foreign Application Priority Data
Sep. 3, 2021 (TW) 110132891
Nov. 10, 2021 (TW) 110141888

(51) Int. Cl. B25B 13/46; B25B 23/00

(52) U.S. Cl. CPC B25B 13/468; B25B 23/0021; B25B 23/0028; B25B 23/0035

(57) ABSTRACT

A wrench extender comprises an extension member, a handle, and an adjustable device, which includes two ratchet wheels disposed between the extension member and the handle, and a biasing member biasing between the two ratchet wheels. The two ratchet wheels are selectively adjusted between a closed position where the two ratchet wheels are abutted against each other and a separated position where the two ratchet wheels are separated and located away from each other. Each ratchet wheel is provided with a third ratchet portion on an outer periphery thereof, wherein the third ratchet portions of the two ratchet wheels are selectively engaged with the first ratchet portion of the extension member in the closed position or simultaneously engaged with the first and second ratchet portions in the separated position.

### CROSS-REFERENCE

The present application is a continuation-in-part application of U.S. patent application Ser. No. 17/894,330, filed on Aug. 24, 2022, now abandoned, which claims priority of Taiwan patent application Ser. No. 110132891, filed on Sep. 3, 2021, and priority of Taiwan patent application Ser. No. 110141888, filed on Nov. 10, 2021, of which the entire disclosure is incorporated herein by reference for all purposes.

### BACKGROUND OF THE INVENTION

The present invention relates to a wrench extender and, more particular, to a wrench extender for increasing torque applicable.

Taiwan Design Patent No. TWD189623 discloses a tool grip with two different type ends, where one end being like an open-end wrench, and the other end being like a box-end wrench.

The main advantage of the above wrench is to provide two different driving types. However, because the user's hand can only grip between the two ends of the wrench to cause the force arm being short, the user needs to use other auxiliary extension tool attach to the wrench for increasing the force arm, but the connection of the auxiliary extension tool and the wrench is limited due to the complex shape of the wrench, so that the auxiliary extension tool cannot be stably connected to the wrench.

Thus, a need exists for a novel wrench extender to mitigate and/or obviate the above disadvantages.

### SUMMARY OF THE INVENTION

An objective of the present invention is to provide a wrench extender including an extension member. The extension member has a wrench supporting base with a supporting face and first and second sides adjacent to the supporting face and respectively disposed at two opposite sides of the supporting face. The wrench supporting base is provided with a first holding portion arranged on the supporting face and adjacent to the first side, and a second holding portion arranged on the supporting face and adjacent to the second side.

In an embodiment, the wrench extender further includes a retaining member arranged on the wrench supporting base to retain a wrench hold by the wrench supporting base.

In an embodiment, the retaining member has a mounting portion connected to the second holding portion, and a retaining portion extended from the mounting portion.

In an embodiment, the mounting portion and the retaining portion are perpendicular each other.

In an embodiment, the second holding portion has a threaded hole.

The mounting portion has a penetrating hole aligned to the threaded hole, and a threaded fastener inserts through the penetrating hole and secures with the threaded hole.

In an embodiment, the wrench supporting base further has a recess formed on the supporting face, and the wrench extender further includes a magnetic member fixedly arranged in the recess.

In an embodiment, the recess is disposed between the first holding portion and the second holding portion.

In an embodiment, the extension member further has an extending portion extended from the wrench supporting base, and the wrench extender further includes a handle pivotally connected to the extending portion.

In an embodiment, a first holding channel is defined between the supporting face and the first holding portion, and a second holding channel is defined between the supporting face and the second holding portion.

In an embodiment, the second holding channel is inclined with respect to the first holding channel.

In an embodiment, a distance defined between the first side and the second side is greater than a distance defined between the first side and a top edge of the first holding portion.

In another embodiment, the retaining member has a mounting portion connected to the first holding portion, and a retaining portion extended from the mounting portion.

In another embodiment, the mounting portion and the retaining portion are perpendicular each other.

In another embodiment, the second holding portion further has a recess formed on an inner wall thereof, and the wrench extender further includes a magnetic member fixedly arranged in the recess.

In another embodiment, the recess is disposed between the second side and a top edge of the second holding portion.

In another embodiment, a distance defined between the first side and the second side is less than a distance defined between the first side and a top edge of the second holding portion.

Another objective of the present invention is to provide a wrench extender comprising an extension member, a handle, and an adjustable device. The extension member has a wrench supporting base with at least one front holding portion, and a pivoting portion with a first ratchet portion. The handle has two second ratchet portions. The adjustable device includes two ratchet wheels disposed between the extension member and the handle, and a biasing member biasing between the two ratchet wheels. The two ratchet wheels are selectively adjusted between a closed position where the two ratchet wheels are abutted against each other and a separated position where the two ratchet wheels are separated and located away from each other. Each of the two ratchet wheels is provided with a third ratchet portion on an outer periphery thereof. The third ratchet portions of the two ratchet wheels are selectively engaged with the first ratchet portion of the extension member or simultaneously engaged with the first and second ratchet portions. When in the closed position, the third ratchet portions are engaged with the first ratchet portion of the extension member with the extension member and the handle pivotable with respect to each other. When in the separated position, the third ratchet portions of the ratchet wheels are engaged with the first and second ratchet portions simultaneously with the extension member and the handle fixed in a non-rotatable manner to each other.

In the embodiment, each of the two ratchet wheels is further provided with a receiving groove in an inner surface thereof. The biasing member has two ends pressed against receiving grooves of the two ratchet wheels to maintain the two ratchet wheels in the separated position in normal conditions.

In the embodiment, each of the two ratchet wheels is further provided a protrusive pressing portion on an outer surface thereof. The pressing portion of each of the two ratchet wheels is smaller in outer diameter than the third ratchet portion of the respective two ratchet wheels.

In the embodiment, the handle is formed with two assembling portions, and the pivoting portion of the extension member pivotably disposed between the two assembling portions. The pivoting portion is defined with a first through hole, and the first ratchet portion is formed on an inner periphery of the first through hole. Each of the two assembling portions is defined with a second through hole in communication with the first through hole, and the two second ratchet portions formed on an inner periphery of the second through holes. An annular groove is formed in an inner periphery of the respective second through holes. The adjustable device further includes two retaining rings disposed in the respective annular grooves of the two assembling portions of the handle. Each of the two retaining rings is provided with an abutting surface for abutting against a lateral surface of the third ratchet portions of the respective two ratchet wheels, and a third through hole for insertion of the pressing portions of the two ratchet wheels.

In the embodiment, the adjustable device further includes two seal covers covering the respective second through holes of the two assembling portions and pressing against the respective ratchet wheels.

In the embodiment, each of the two ratchet wheels is formed with a positioning hole in the outer surface thereof, and each of the two seal covers is formed with a fourth through hole. Two positioning pins are inserted through the respective fourth through holes of the two seal covers and positioned in the positioning holes of the respective two ratchet wheels.

In the embodiment, the number of the at least one front holding portions is two, wherein the two front holding portions are parallel to each other, and the wrench supporting base is further provided with a rear holding portion adjacent to the pivoting portion.

The present invention will become clearer in light of the following detailed description of illustrative embodiments of this invention described in connection with the drawings.

The present invention will become clearer in light of the following detailed description of illustrative embodiments of this invention described in connection with the drawings.

### BRIEF DESCRIPTION OF DRAWINGS

FIG. 1 is a perspective view of a wrench extender of a first embodiment according to the present invention.

FIG. 2 is an enlarged partial exploded perspective view of the wrench extender of FIG. 1.

FIG. 3 is a cross sectional view of the wrench extender of FIG. 1 and shows a retaining member mounted on a second holding portion.

FIG. 4 is another cross sectional view of the wrench extender of FIG. 1 and shows a magnetic member mounted to a recess of a wrench supporting base.

FIG. 5 is a perspective view of the wrench extender of FIG. 1 and shows the wrench extender hold a wrench.

FIG. 6 is a partial perspective view of a wrench extender of a second embodiment according to the present invention.

FIG. 7 is another partial perspective view of the wrench extender of FIG. 6.

FIG. 8 is another perspective view of the wrench extender of FIG. 6.

FIG. 9 is a perspective view of a wrench extender of a third embodiment according to the present invention.

FIG. 10 is an enlarged partial exploded perspective view of the wrench extender of FIG. 9.

FIG. 11 is a cross sectional view of the wrench extender of FIG. 9 and shows two ratchet wheels in a separated position.

FIG. 12 is continued view of the wrench extender of FIG. 11 and shows two ratchet wheels in a closed position.

FIG. 13 is a side view of the wrench extender of FIG. 9 and shows the extension member holding a wrench.

### DETAILED DESCRIPTION OF THE INVENTION

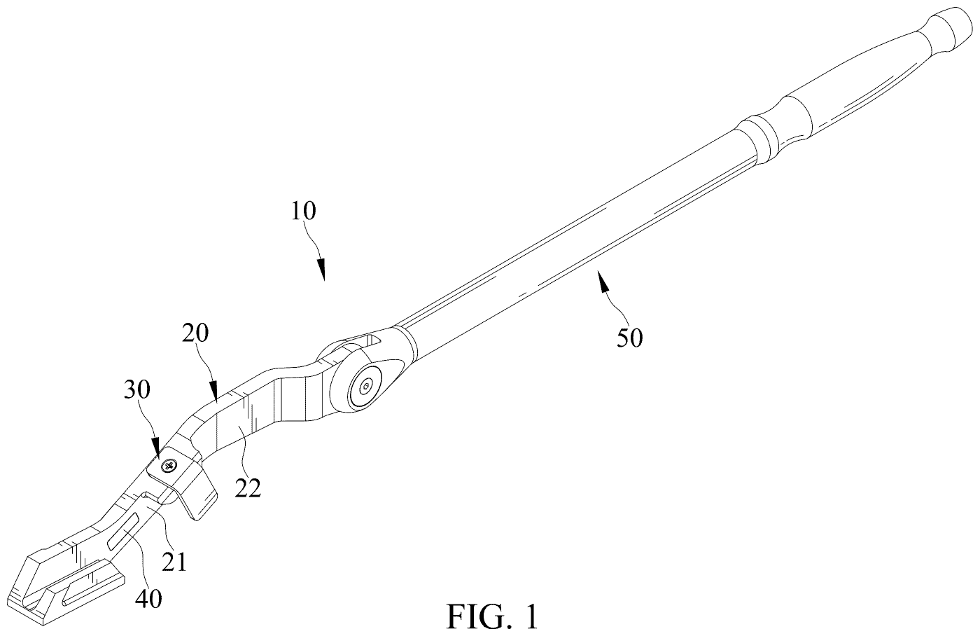

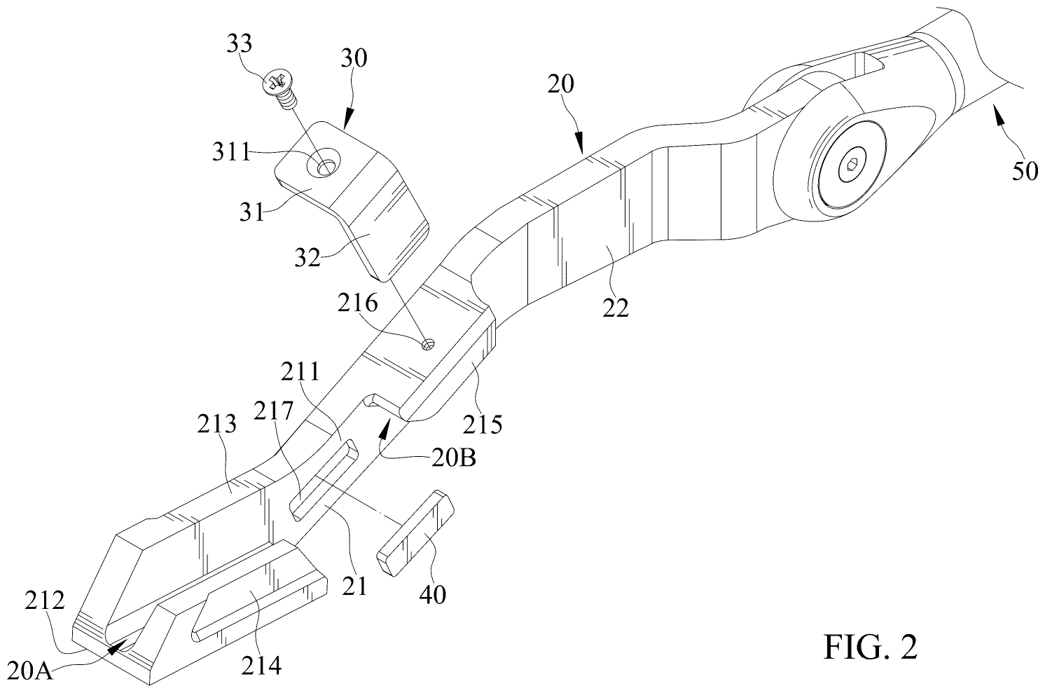

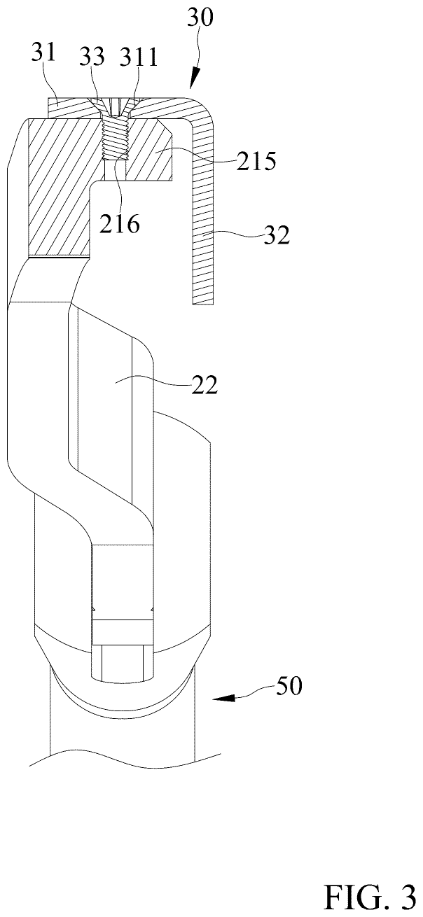

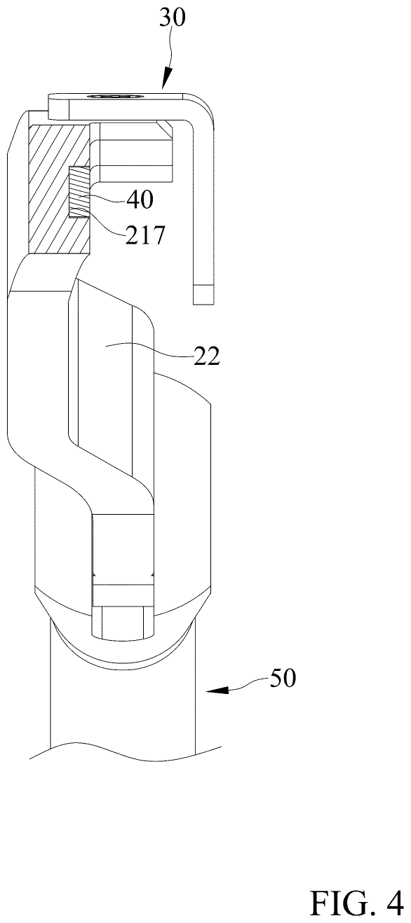

FIGS. 1-5 show a wrench extender 10 of a first embodiment according to the present invention. The wrench extender 10 includes an extension member 20 and a retaining member 30. The extension member 20 has a wrench supporting base 21 with a supporting face 211 and first and second sides 212,213 adjacent to the supporting face 211 and respectively disposed at two opposite sides of the supporting face 211. The wrench supporting base 21 is provided with a first holding portion 214 arranged on the supporting face 211 and adjacent to the first side 212, and a second holding portion 215 arranged on the supporting face 211 and adjacent to the second side 213. The retaining member 30 is arranged on the wrench supporting base 21 to retain a wrench 60 hold by the wrench supporting base 21.

The retaining member 30 has a mounting portion 31 connected to the second holding portion 215, and a retaining portion 32 extended from the mounting portion 31. Further, the mounting portion 31 and the retaining portion 32 may be perpendicular each other so that the retaining member 30 is formed as an L-shaped structure.

In order to connect the mounting portion 31 of the retaining member 30 to the second holding portion 215 of the wrench supporting base 21, the second holding portion 215 has a threaded hole 216, the mounting portion 31 has a penetrating hole 311 aligned to the threaded hole 216, and a threaded fastener 33 inserts through the penetrating hole 311 and secures with the threaded hole 216.

Further, the wrench supporting base 21 further has a recess 217 formed on the supporting face 211, and the wrench extender 10 further includes a magnetic member 40 fixedly arranged in the recess 217. Thus, the magnetic member 40 can magnetically attract the wrench 60 when the wrench 60 hold by the wrench supporting base 21. Furthermore, the recess 217 may be disposed between the first holding portion 214 and the second holding portion 215.

In the embodiment, the extension member 20 further has an extending portion 22 extended from the wrench supporting base 21, and the wrench extender 10 further includes a handle 50 pivotally connected to the extending portion 22.

A first holding channel 20A is defined between the supporting face 211 and the first holding portion 214, and a second holding channel 20B is defined between the supporting face 211 and the second holding portion 215. In the embodiment, the second holding channel 20B is inclined with respect to the first holding channel 20A.

Further, a distance defined between the first side 212 and the second side 213 is greater than a distance defined between the first side 212 and a top edge of the first holding portion 214.

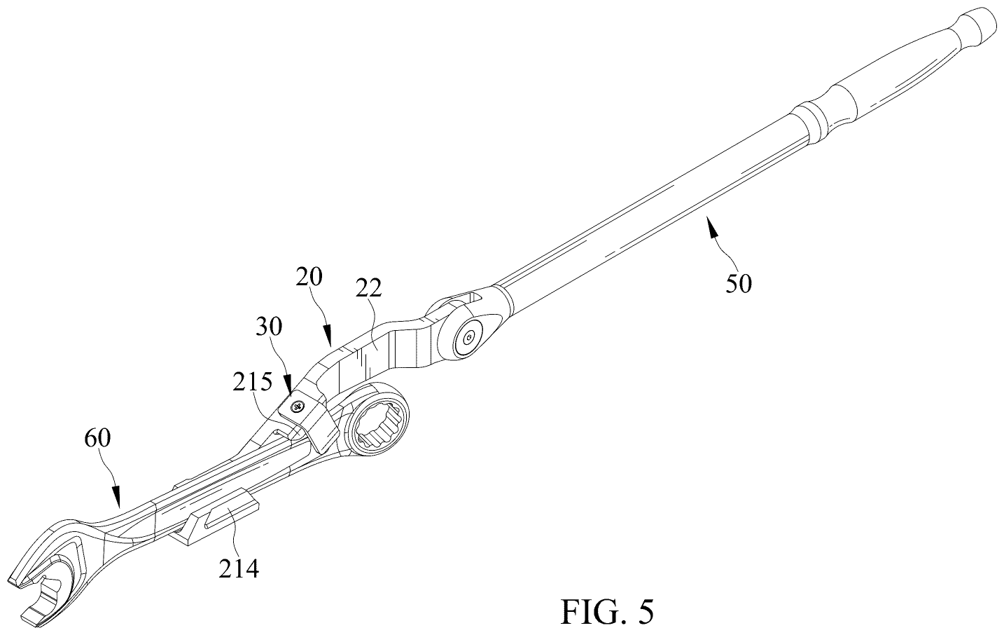

As such, as shown in FIG. 5, when the wrench 60 is attached to the wrench supporting base 21 to be hold in the first holding channel 20A and the second holding channel 20B, the middle portion of the wrench 60 is held by the first holding portion 214, and the right potion adjacent to the box-end of the wrench 60 is held by the second holding portion 215 and the retaining member 30. In addition, the magnetic member 40 can magnetically attract the wrench 60. Thus, the wrench 60 is stably held by the wrench supporting base 21 and is not easy to detach therefrom due to force or shaking.

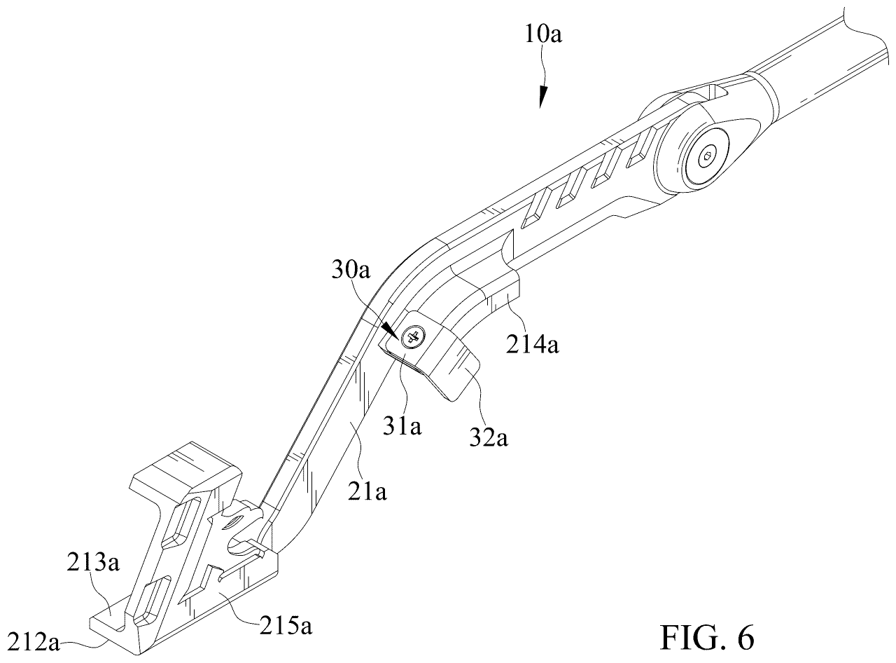

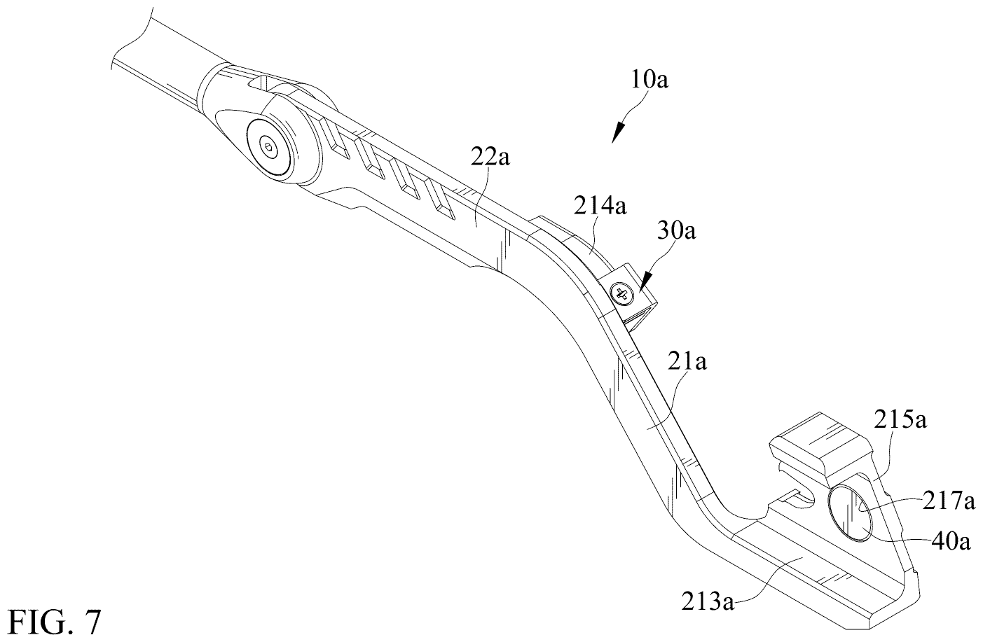

FIGS. 6-8 show a wrench extender 10a of a second embodiment according to the present invention. The second embedment is substantially the same as the first embodiment. The main differences are that the retaining member 30a has a mounting portion 31a connected to the first holding portion 214a, and a retaining portion 32a extended from the mounting portion 31a. Further, the mounting portion 31a and the retaining portion 32a are perpendicular each other.

The second holding portion 215a further has a recess 217a formed on an inner wall thereof, and the wrench extender 10a further includes a magnetic member 40a fixedly arranged in the recess 217a. Further, the recess 217a is disposed between the second side 213a and a top edge of the second holding portion 215a.

Furthermore, a distance defined between the first side 212a and the second side 213a is less than a distance defined between the first side 212a and a top edge of the second holding portion 215a.

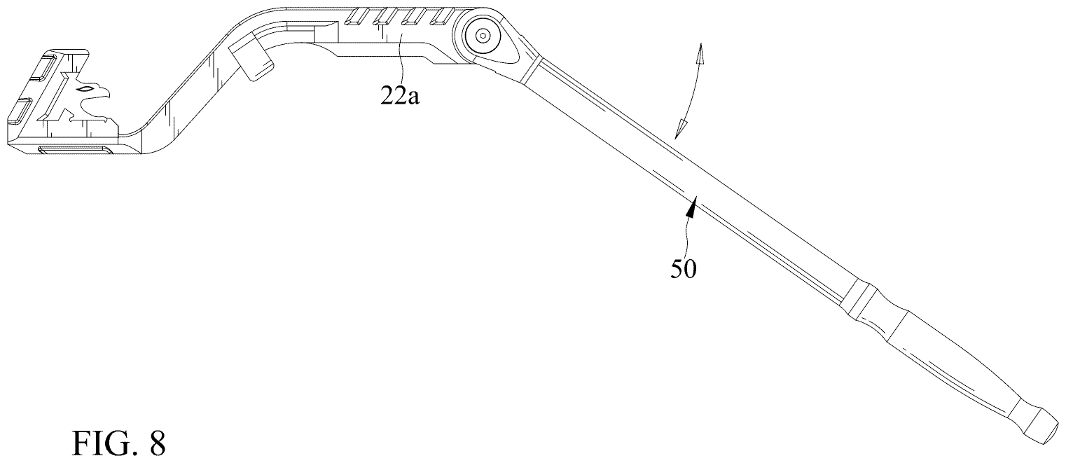

FIG. 8 shows the extending portion 22a can be selectively adjusted the varying included angle with respect to the handle 50. A locking mechanism may be arranged between the extending portion 22a and the handle 50.

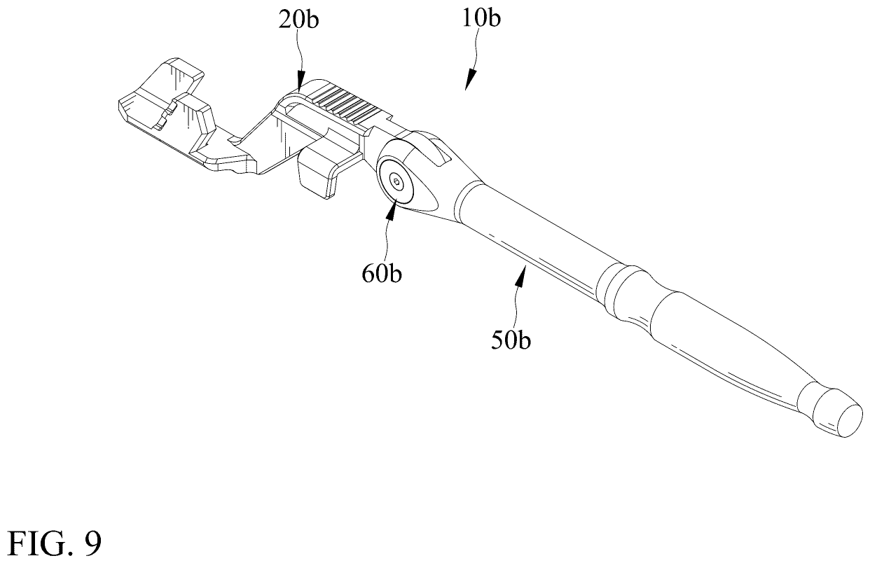

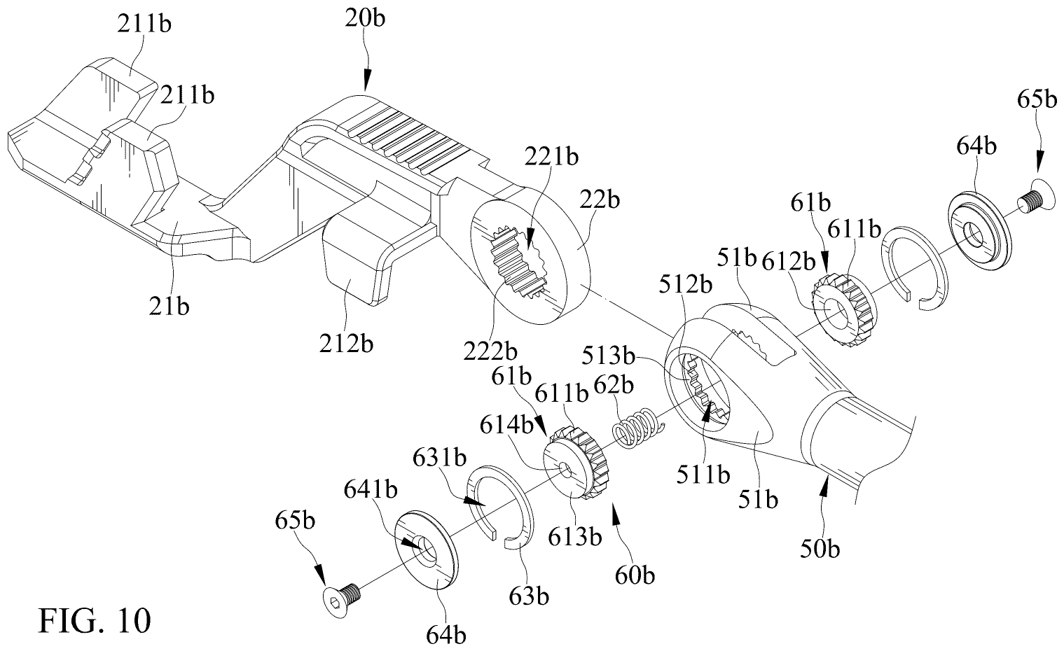

FIGS. 9-13 show a wrench extender 10b of a third embodiment according to the present invention. The wrench extender 10b comprises an extension member 20b, a handle 50b, and an adjustable device 60b. The extension member 20b has a wrench supporting base 21b and a pivoting portion 22b. The wrench supporting base 21b has two front holding portions 211b parallel to each other, and a rear holding portion 212b adjacent to the pivoting portion 22b. The pivoting portion 22b is defined with a first through hole 221b, and a first ratchet portion 222b is formed on an inner periphery of the first through hole 221b.

The handle 50b is formed with two assembling portions 51b, and the pivoting portion 22b of the extension member 20b pivotably disposed between the two assembling portions 51b. Each of the two assembling portions 51b is defined with a second through hole 511b in communication with the first through hole 221b, and two second ratchet portions 512b formed on an inner periphery of the second through holes 511b. Further, an annular groove 513b is formed in an inner periphery of the respective second through holes 511b.

The adjustable device 60b includes two ratchet wheels 61b disposed between the extension member 20b and the handle 50b, and a biasing member 62b biasing between the two ratchet wheels 61b. The two ratchet wheels 61b are selectively adjusted between a closed position where the two ratchet wheels 61b are abutted against each other and a separated position where the two ratchet wheels 61b are separated and located away from each other. Each of the two ratchet wheels 61b is provided with a third ratchet portion 611b on an outer periphery thereof. The third ratchet portions 611b of the two ratchet wheels 61b are selectively engaged with the first ratchet portion 222b of the extension member 20b or simultaneously engaged with the first and second ratchet portions 222b and 512b. When in the closed position, the third ratchet portions 611b are engaged with the first ratchet portion 222b of the extension member 20b with the extension member 20b and the handle 50b pivotable with respect to each other; When in the separated position, the third ratchet portions 611b of the ratchet wheels 61b are engaged with the first and second ratchet portions 222b, 512b simultaneously with the extension member 20b and the handle 50b fixed in a non-rotatable manner to each other.

Further, each of the two ratchet wheels 61b is provided with a receiving groove 612b in an inner surface thereof, a protrusive pressing portion 613b on an outer surface thereof, and two retaining rings 63b disposed in the respective annular grooves 513b of the two assembling portions 51b of the handle 50b. The biasing member 62b has two ends pressed against receiving grooves 612b of the two ratchet wheels 61b to maintain the two ratchet wheels 61b in the separated position in normal conditions. The pressing portion 613b of each of the two ratchet wheels 61b is smaller in outer diameter than the third ratchet portion 611b of the respective two ratchet wheels 61b. Each of the two retaining rings 63b is provided with an abutting surface for abutting against a lateral surface of the third ratchet portions 611b of the respective two ratchet wheels 61b, and a third through hole 631b for insertion of the pressing portions 613b of the two ratchet wheels 61b.

The adjustable device 60b further includes two seal covers 64b covering the respective second through holes 511b of the two assembling portions 51b and pressing against the respective ratchet wheels 61b.

Each of the two ratchet wheels 61b is formed with a positioning hole 614b in the outer surface thereof, and each of the two seal covers 64b is formed with a fourth through hole 641b. Two positioning pins 65b are inserted through the respective fourth through holes 641b of the two seal covers 64b and positioned in the positioning holes 614b of the respective two ratchet wheels 61b.

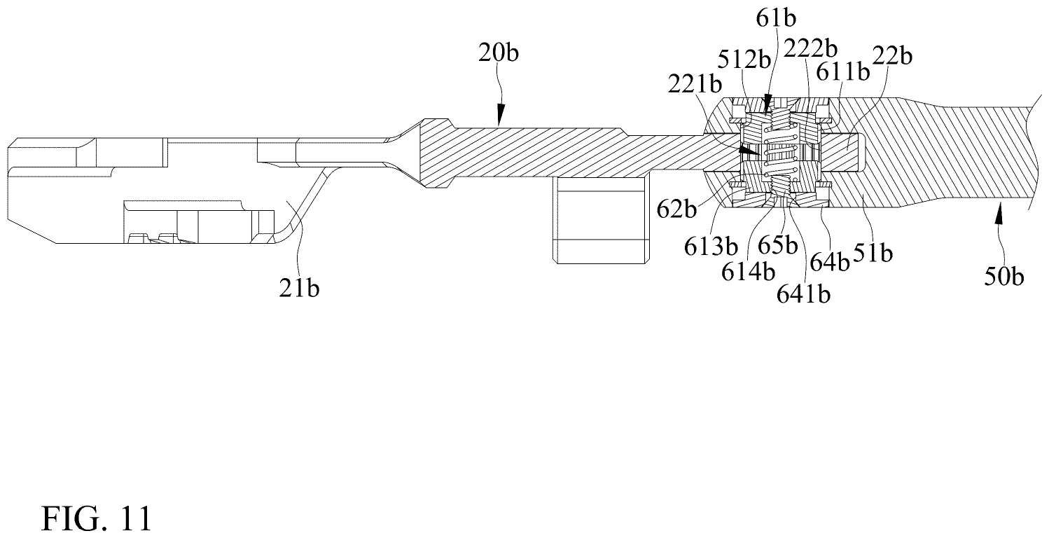

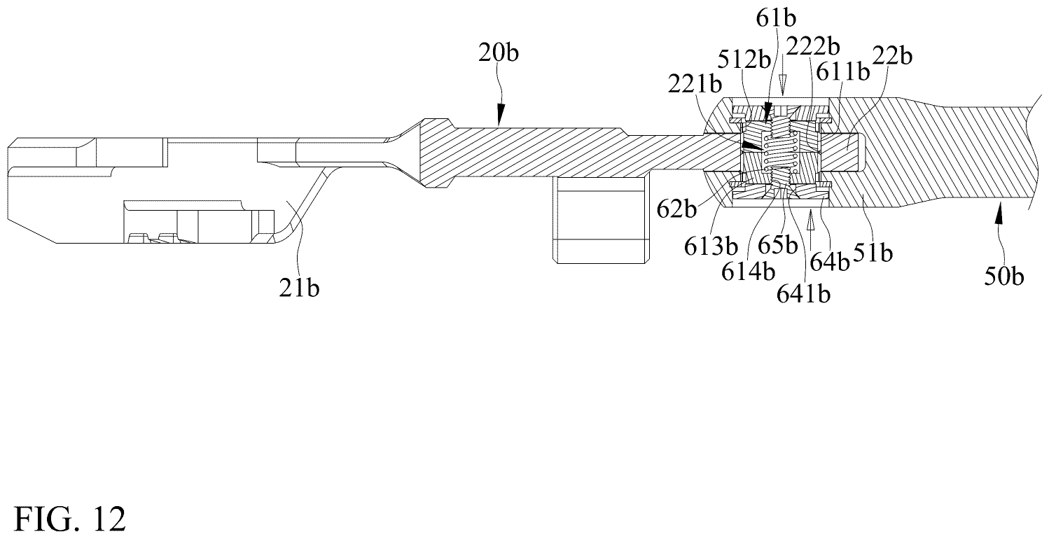

The above is the summary of the positional and structural relationships among the respective components of the preferred embodiment according to the present invention. Under normal conditions, as shown in FIG. 11, the two opposite ends of the biasing member 62b respectively push the two ratchet wheels 61b outwards (into a separated position where the two ratchet wheels 61b are spaced apart), causing the third ratchet portions 611b of the two ratchet wheels 61b to simultaneously engage with the first ratchet portion 222b of the extension member 20b and the two second ratchet portions 512b of the handle 50b. Consequently, the two ratchet wheels 61b can be engaged with both the extension member 20b and the handle 50b, allowing the extension member 20b to be fixed relative to the handle 50b and operated by a user as shown in FIGS. 11 and 12.

To adjust the angle of the extension member 20b relative to the handle 50b, the two seal covers 64b can be pressed, causing the two ratchet wheels 61b to move inward and compress the biasing member 62b. When the two ratchet wheels 61b move toward each other, the third ratchet portions 611b of the two ratchet wheels 61b disengage from the two second ratchet portion 512b of the handle 50b and fully engage with the first ratchet portion 222b of the extension member 20b, as shown in FIG. 12. This disengagement allows the two ratchet wheels 61b to rotate without interference from the two second ratchet portions 512b of the handle 50b. As a result, the extension member 20b can be rotated synchronously with the two ratchet wheels 61b, allowing adjustment to a desired angle.

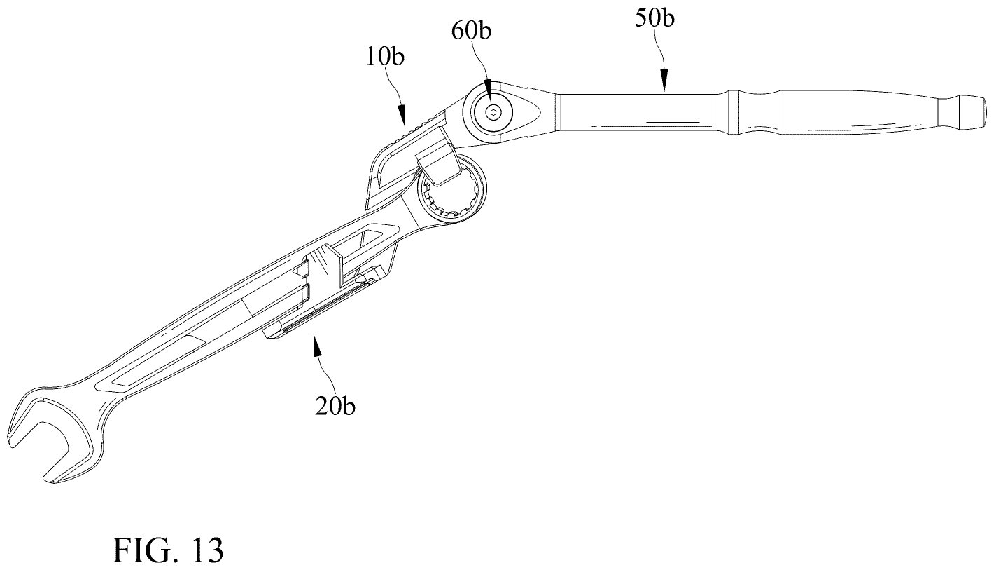

As shown in FIG. 13, the user will release pressure on the two ratchet wheels 61b once the extension member 20b is adjusted to the desired angle. At this point, the biasing member 62b will elastically restore to its original shape, pushing the two ratchet wheels 61b apart and back to the separated position where the third ratchet portions 611b of the two ratchet wheels 61b simultaneously engage with the first ratchet portion 222b of the extension member 20b and the two second ratchet portions 512b of the handle 50b. This enables the user to use the extension member 20b, now adjusted to the desired angle, to carry out an operation.

Additionally, since the present invention uses the two symmetrically-arranged ratchet wheels 61b to compress the biasing member 62b, each ratchet wheel 61b receives the same force and travels the same distance when pressed. This design prevents misalignment of the ratchet wheels 61b, avoiding any ratchet jamming caused by such misalignment.

Although specific embodiments have been illustrated and described, numerous modifications and variations are still possible without departing from the scope of the invention. The scope of the invention is limited by the accompanying claims.

1. A wrench extender comprising:
an extension member having a wrench supporting base with at least one front holding portion;
a handle connected with the extension member; and
an adjustable device disposed between the extension member and the handle, and configured to control a relative position between the extension member and the handle.

2. The wrench extender as claimed in claim 1, wherein the extension member further has a pivoting portion with a first ratchet portion, wherein the handle has two second ratchet portions, wherein the adjustable device includes two ratchet wheels disposed between the extension member and the handle, and a biasing member biasing between the two ratchet wheels, wherein the two ratchet wheels are selectively adjusted between a closed position where the two ratchet wheels are abutted against each other and a separated position where the two ratchet wheels are separated and located away from each other, wherein each of the two ratchet wheels is provided with a third ratchet portion on an outer periphery thereof, wherein the third ratchet portions of the two ratchet wheels are selectively engaged with the first ratchet portion of the extension member or simultaneously engaged with the first and second ratchet portions, wherein when in the closed position, the third ratchet portions are engaged with the first ratchet portion of the extension member with the extension member and the handle pivotable with respect to each other, and wherein when in the separated position, the third ratchet portions of the ratchet wheels are engaged with the first and second ratchet portions simultaneously with the extension member and the handle fixed in a non-rotatable manner to each other.

3. The wrench extender as claimed in claim 2, wherein each of the two ratchet wheels is further provided with a receiving groove in an inner surface thereof, wherein the biasing member having two ends pressed against receiving grooves of the two ratchet wheels to maintain the two ratchet wheels in the separated position in normal conditions.

4. The wrench extender as claimed in claim 3, wherein each of the two ratchet wheels is further provided a protrusive pressing portion on an outer surface thereof, wherein the pressing portion of each of the two ratchet wheels is smaller in outer diameter than the third ratchet portion of the respective two ratchet wheels.

5. The wrench extender as claimed in claim 4, wherein the handle is formed with two assembling portions, wherein the pivoting portion of the extension member pivotably disposed between the two assembling portions, wherein the pivoting portion is defined with a first through hole, wherein the first ratchet portion is formed on an inner periphery of the first through hole, wherein each of the two assembling portions is defined with a second through hole in communication with the first through hole, wherein the two second ratchet portions are formed on an inner periphery of the second through holes, wherein an annular groove is formed in an inner periphery of the respective second through holes, wherein the adjustable device further includes two retaining rings disposed in the respective annular grooves of the two assembling portions of the handle, and wherein each of the two retaining rings is provided with an abutting surface for abutting against a lateral surface of the third ratchet portions of the respective two ratchet wheels, and a third through hole for insertion of the pressing portions of the two ratchet wheels.

6. The wrench extender as claimed in claim 5, wherein the adjustable device further includes two seal covers covering the respective second through holes of the two assembling portions and pressing against the respective ratchet wheels.

7. The wrench extender as claimed in claim 6, wherein each of the two ratchet wheels is formed with a positioning hole in the outer surface thereof, wherein each of the two seal covers is formed with a fourth through hole, and wherein two positioning pins are inserted through the respective fourth through holes of the two seal covers and positioned in the positioning holes of the respective two ratchet wheels.

8. The wrench extender as claimed in claim 1, wherein the number of the at least one front holding portions is two, wherein the two front holding portions are parallel to each other, and wherein the wrench supporting base is further provided with a rear holding portion adjacent to the pivoting portion.
